(19) United States
(12) Patent Application Publication
(10) Pub. No.: US 2007/0180457 A1
(43) Pub. Date: Aug. 2, 2007

(54) Disk device provided with tray

(75) Inventor: Takeshi Makino, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/653,961

(22) Filed: Jan. 17, 2007

(30) Foreign Application Priority Data
Jan. 30, 2006 (JP) 2006-020787

(51) Int. Cl. G11B 17/04; G11B 33/02

(52) U.S. Cl. 720/613

(57) ABSTRACT

A disk device provided with a tray capable of suppressing an abrupt inclination of the tray and moving the tray in a stable condition is provided. When moving the tray 2 from a disk reproducing position to a disk loading/unloading position, the tray 2 becomes most unstable when a position of the center of gravity S of the tray 2 reaches a front wall 10C of a frame 10, but making an inclination relaxation rib 17 contact a top surface of the back end of a guide rail 13 at the position causes the tray 2 to move without abruptly inclining.

The present application is based on and claims priority of Japanese patent application No. 2006-020787 filed on Jan. 30, 2006, the entire contents of which are hereby incorporated by reference.

### BACKGROUND OF THE INVENTION

1. Field of the Invention

The present invention relates to a disk device which guides a disk-shaped storage medium (hereinafter, simply referred to as a “disk”) between a disk loading/unloading position and a disk reproducing position in a manner freely movable back and forth and records or reproduces the disk at the disk reproducing position, and more particularly, to a disk device which can suppress an abrupt inclination of the tray which occurs when the tray is carried out of the disk reproducing position and moved.

2. Description of the Related Art

Conventionally, a disk device which records or reproduces data onto/from a disk is not limited to a stationary DVD player and a CD player or the like, but the application thereof extends over a wide range, for example, it is also incorporated in the main body of a television receiver. Such a disk device is provided with a tray on which a disk is mounted, a resin frame which supports the tray in a freely movable manner and a pickup unit which irradiates a storage surface of the disk with laser light and reproduces data from the disk or records data onto the storage surface as main components. When recording or reproducing data onto/from the disk, the tray is moved to the disk loading/unloading position outside the frame, the disk is mounted on the tray and the tray is then moved to the disk reproducing position. When the tray is moved to the disk reproducing position, an end of a turntable is engaged with an opening substantially in the center of the disk mounted on the tray, the disk is made to float from the tray, the floating disk is held between the turntable and a clamper, the disk is made to rotate by a rotation drive force of a motor attached to the turntable, information is written and recorded into the disk by a pickup unit or information recorded on the disk is read and reproduced.

However, when the tray which is carried out and moved from the disk reproducing position to the disk loading/unloading position protrudes farther than when the center of gravity of the tray is located between a part of the tray which protrudes from the frame and another part of the tray inside the frame, the tray inclines abruptly by the own weight of the tray which protrudes from the frame, which constitutes a factor for causing the quality of the disk device to significantly degrade. For this reason, for example, Japanese Patent Laid-Open Publication No. 2004-259336 (patent document 1) describes a case where guide grooves formed at edges on both sides of the underside of the tray are made to engage with guide members formed in the frame, the tray is thereby guided from the disk loading/unloading position to the disk reproducing position in a manner freely movable back and forth and a plurality of stoppers protruding from inner surfaces of right and left side walls of the frame are provided to prevent the tray from floating while moving. Furthermore, the disk device disclosed in patent document 1 forms a slit in one side of a synthetic resin top plate integrally formed between left and right side walls of the frame to thereby form a substantially L-shaped pushing piece so as to prevent an abrupt inclination of the tray while moving elastically contact a top surface of one side edge of the tray and at the same time forms a substantially U-shaped arc surface in the frame and causes the arc surface to elastically contact the guide grooves of the tray so as to suppress sideward backlash of the tray.

The disk device described in patent document 1 makes the pushing piece formed in the top plate elastically contact the top surface of the tray to suppress the inclination of the tray in the vertical direction, at the same time makes the U-shaped arc surface formed in the frame elastically contact the guide grooves of the tray so as to suppress backlash of the tray in the horizontal direction, and therefore pushing forces of the pushing piece while the tray moves and the arc surface are always applied to the tray and excessive contact with the pushing piece and the arc surface may cause friction and produce abnormal sound or abrasion powder or the like. Furthermore, molding and working on the pushing piece and arc surface is also complicated, resulting in a problem of causing an increase in cost.

### SUMMARY OF THE INVENTION

The present invention has been implemented in view of the above described problems and it is an object of the present invention to provide a disk device provided with a tray having a simple and low-cost structure, capable of effectively suppressing an abrupt inclination of the tray and suppressing the generation of abnormal sound and abrasion powder or the like when moving the tray.

The disk device provided with a tray according to a first aspect of the present invention is a disk device provided with a tray including a tray on which a disk-shaped storage medium is mounted, a frame which supports the tray and guiding means for guiding the tray between a disk loading/unloading position and a disk reproducing position in a manner freely movable back and forth, wherein the frame is provided with inclination relaxation means for suppressing an abrupt inclination of the tray which occurs when the tray is carried out of the frame and moved.

According to the first aspect of the present invention, the disk is set in the tray at the disk loading/unloading position at which the tray protrudes from the frame or the disk is removed from the tray. When recording or reproducing data onto/from the disk, the disk mounted on the tray is completely accommodated inside the frame by moving the tray to the inside of the frame through a drive mechanism. The position in this condition is the disk reproducing position and when the disk on the tray is moved to the disk reproducing position, a turntable ascends, the disk is made to rotate by the rotation of the turntable driven by a rotation drive force of a motor with the disk being held between the turntable and a clamper, and at the same time laser light is irradiated from a pickup unit, the pickup unit moves in a radial direction of the disk and recording or reproducing processing on the disk is executed. Furthermore, according to a conventional art, when the tray is carried out and moved by the drive mechanism from the disk reproducing position to the disk loading/unloading position, the tray inclines abruptly at a position where the weight of the tray protruding from the frame becomes greater than the weight of the tray inside the frame, but according to the present invention, the tray is carried out with such an abrupt inclination suppressed by the inclination relaxation means.

The disk device provided with a tray according to a second aspect of the present invention is the disk device provided with a tray according to the first aspect of the present invention, wherein the frame is provided with a horizontal plane which guides the tray and side walls integrally formed on both left and right sides of the horizontal plane, the guide means comprises guide rails formed in undersides of both edges of the tray and engaging projections which protrude from the horizontal plane and engage with recessed grooves of the guide rails, and a plurality of guide ribs are integrally formed on inner surfaces of the side walls of the frame so as to contact top surfaces of the guide rails and suppress floating of the tray.

According to the second aspect of the present invention, when moving the tray through the drive mechanism, the engaging projections which protrude from the horizontal planes of the frame engage with the recessed grooves formed in the guide rails of the tray and the tray is moved along the engaging projections from the disk loading/unloading position to the disk reproducing position or from the disk reproducing position to the disk loading/unloading position. At this time, the plurality of guide ribs formed on inner sides of the side walls of the frame contact the top surfaces of the guide rails and the guide ribs suppress floating of the tray.

The disk device provided with a tray according to a third aspect of the present invention is the disk device provided with a tray according to the first or the second aspect of the present invention, wherein the inclination relaxation means is provided so as to contact a top surface of a back part of the tray when a center of gravity of the tray is located between a part of the tray which at least protrudes from the frame and another part of the tray inside the frame.

According to the third aspect of the present invention, when the center of gravity of the tray is located between a part of the tray which protrudes from the frame and another part of the tray inside the frame, the top surface of the back part of the tray contacts the inclination relaxation means.

The disk device provided with a tray according to a fourth aspect of the present invention is the disk device provided with a tray according to the third aspect of the present invention, wherein the inclination relaxation means is constructed of an inclination relaxation rib which is located between the guide ribs and integrally formed on an inner surface of the side wall.

According to the fourth aspect of the present invention, when the center of gravity of the tray is located between a part of the tray which protrudes from the frame and another part of the tray inside the frame, the top surface of the back part of the tray contacts the inclination relaxation ribs thereby suppressing such a fluctuation that the tray abruptly inclines. Furthermore, the inclination relaxation ribs also function as the guide ribs to suppress floating of the tray.

The disk device provided with a tray according to a fifth aspect of the present invention is the disk device provided with a tray according to the fourth aspect of the present invention, wherein inclined planes or curved planes are formed on the underside of the inclination relaxation rib which contacts the tray in such a way as to gradually lower from an end on the tray receiving side in a direction in which the tray is inserted from the disk loading/unloading position to the disk reproducing position.

According to the fifth aspect of the present invention, when moving the tray from the disk loading/unloading position to the disk reproducing position, the back edges of the guide rails of the tray are smoothly guided by the inclined planes or curved planes of the inclination relaxation ribs and the guide rails are reliably guided to the inclination relaxation ribs.

The disk device provided with a tray according to a sixth aspect of the present invention is the disk device provided with a tray according to the fifth aspect of the present invention, wherein downward inclined planes or curved planes are formed at back ends of the guide rails.

According to the sixth aspect of the present invention, when moving the tray from the disk loading/unloading position to the disk reproducing position, the guide rails of the tray are smoothly guided by the inclined planes formed at the back edges of the guide rails and the inclination relaxation ribs and the guide rails are reliably guided to the inclination relaxation ribs.

### BRIEF DESCRIPTION OF THE DRAWINGS

FIG. 1 is a perspective view of a disk device showing an embodiment of the present invention;

FIG. 2 is a perspective view showing a frame as a single unit according to the above described embodiment;

FIG. 3 is a plan view showing the frame as a single unit according to the above described embodiment;

FIG. 4 is a cross-sectional view showing the frame as a single unit according to the above described embodiment;

FIG. 5 is a perspective view showing a tray as a single unit according to the above described embodiment;

FIG. 6 shows the tray as a single unit according to the above described embodiment, FIG. 6A showing a plan view and FIG. 6B showing a back view;

FIG. 7 is a perspective view of the disk device according to the above described embodiment showing a state in which the cover has been removed;

FIG. 8 is a plan view of the disk device according to the above described embodiment in a state in which the cover has been removed at the disk reproducing position;

FIG. 9 is a plan view of the disk device according to the above described embodiment with the cover removed showing a moving condition of the tray;

FIG. 10 is a plan view of the disk device according to the above described embodiment with the cover removed at the disk loading/unloading position; and

FIG. 11 is a cross-sectional view showing moving conditions of the tray according to the above described embodiment, FIG. 11A showing the disk reproducing position, FIG. 11B showing a state in which the inclination relaxation rib contacts the tray back end and FIG. 11C showing the disk loading/unloading position.

### DETAILED DESCRIPTION OF THE PREFERRED EMBODIMENTS

Hereinafter, a specific embodiment of the present invention will be explained with reference to attached drawings. It should be noted that the following embodiment is a mode of implementing the present invention and is by no means intended to confine the present invention within the scope thereof.

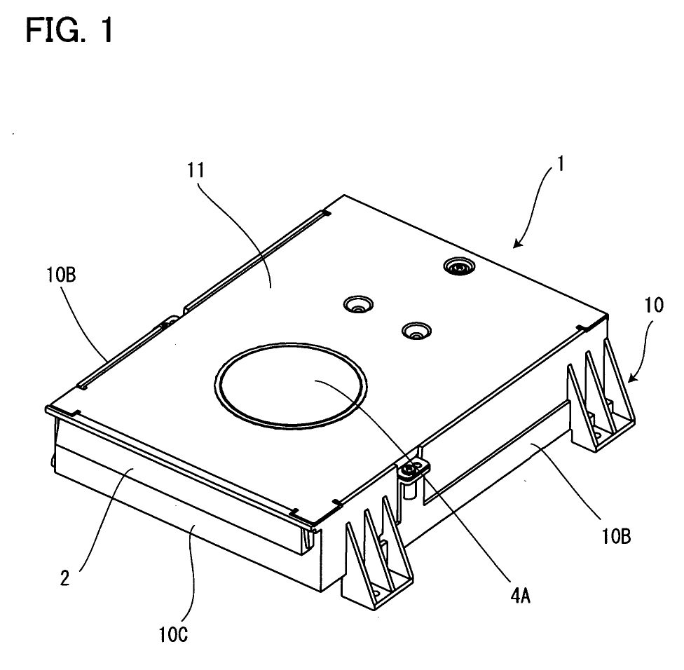

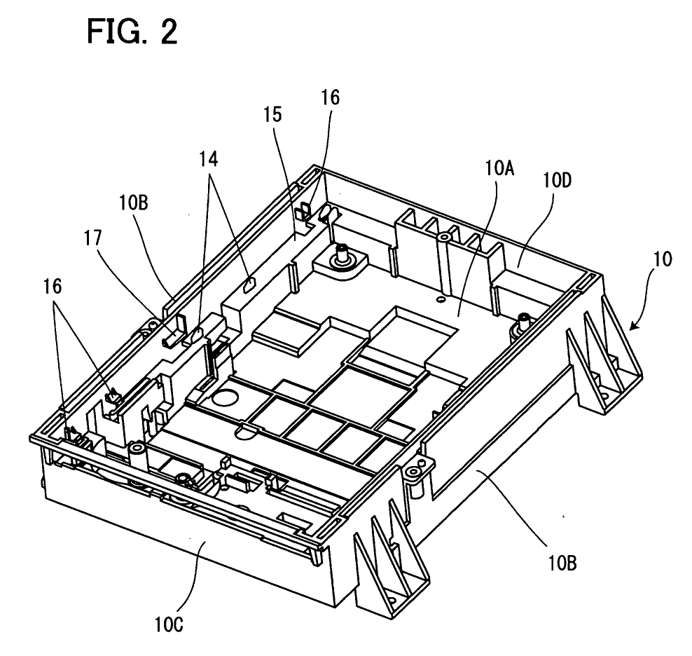

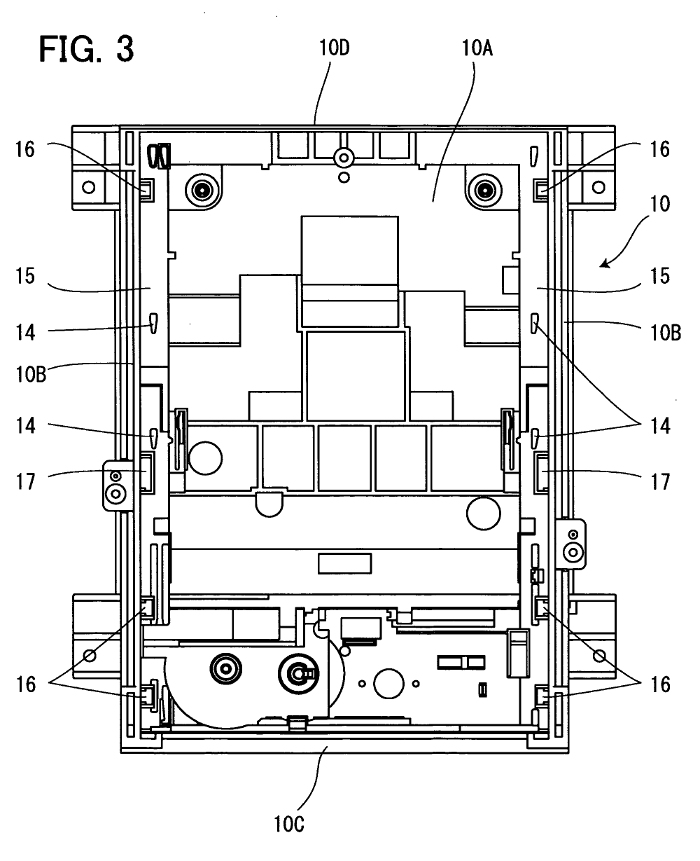

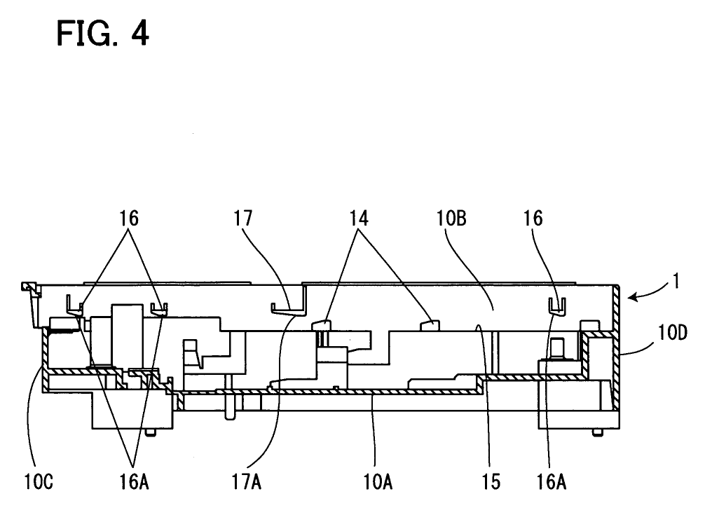

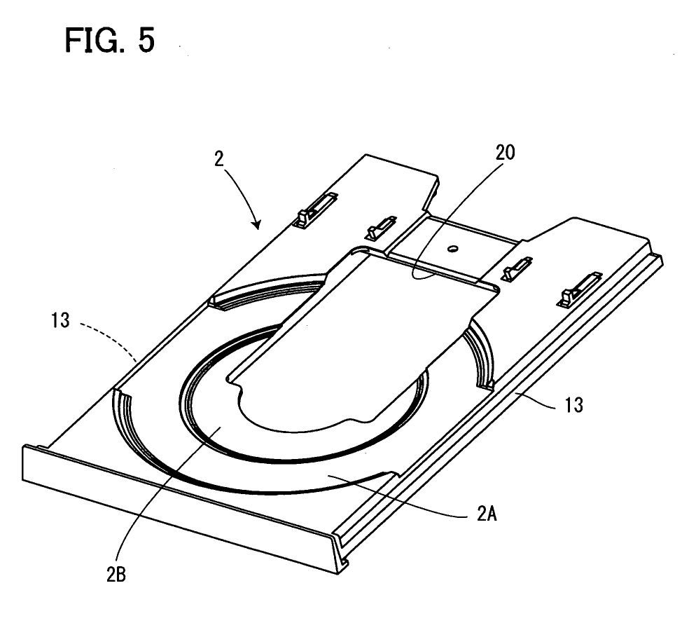

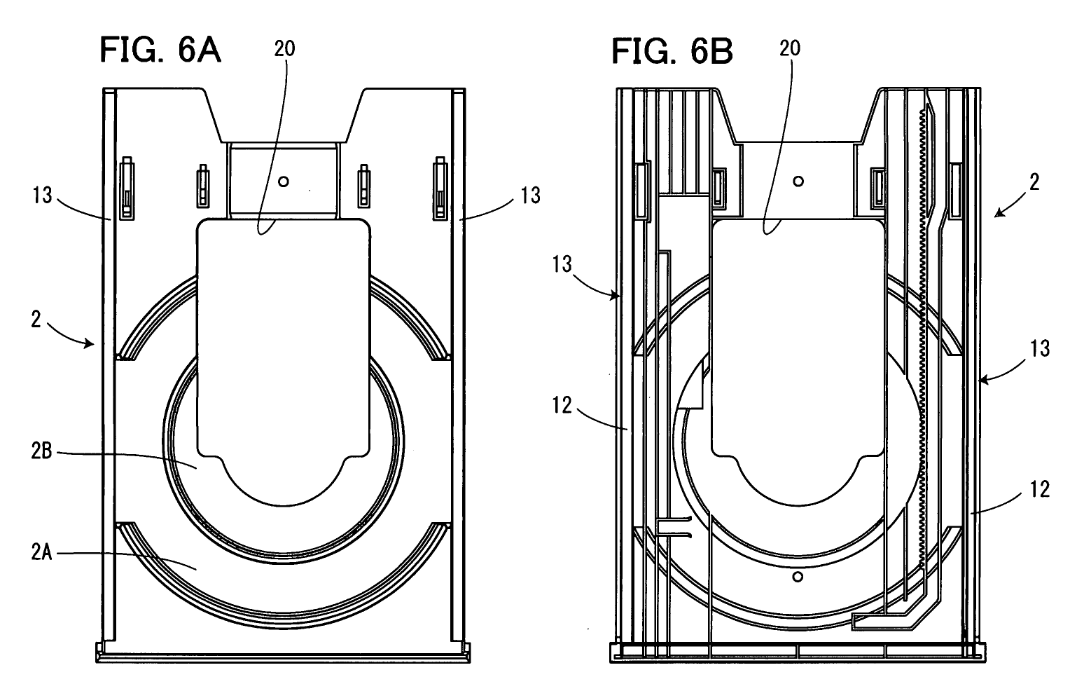

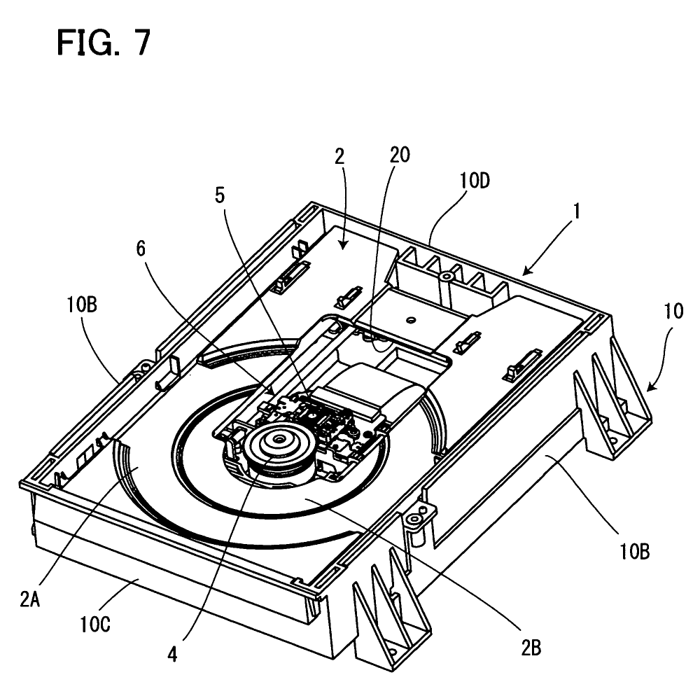

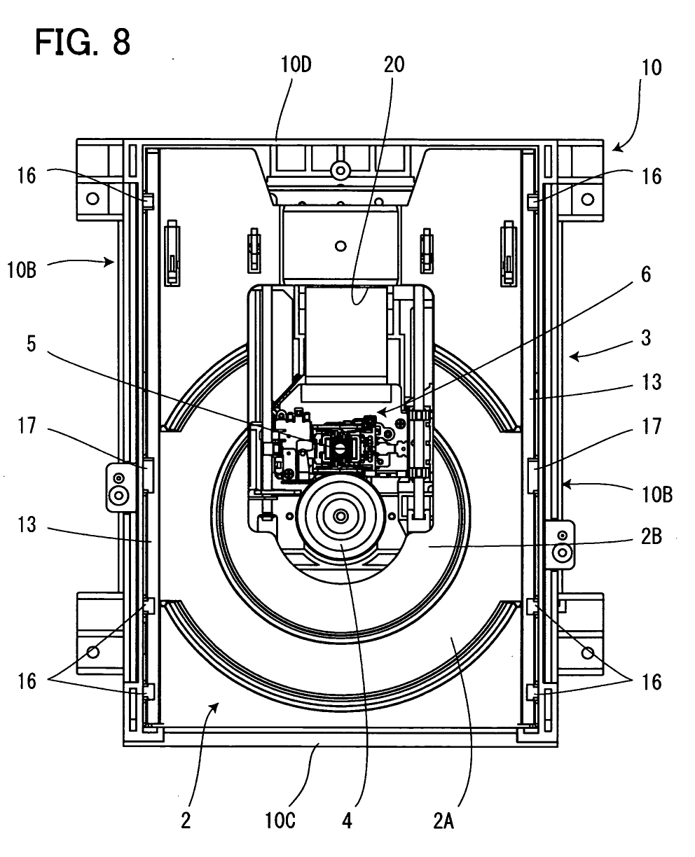

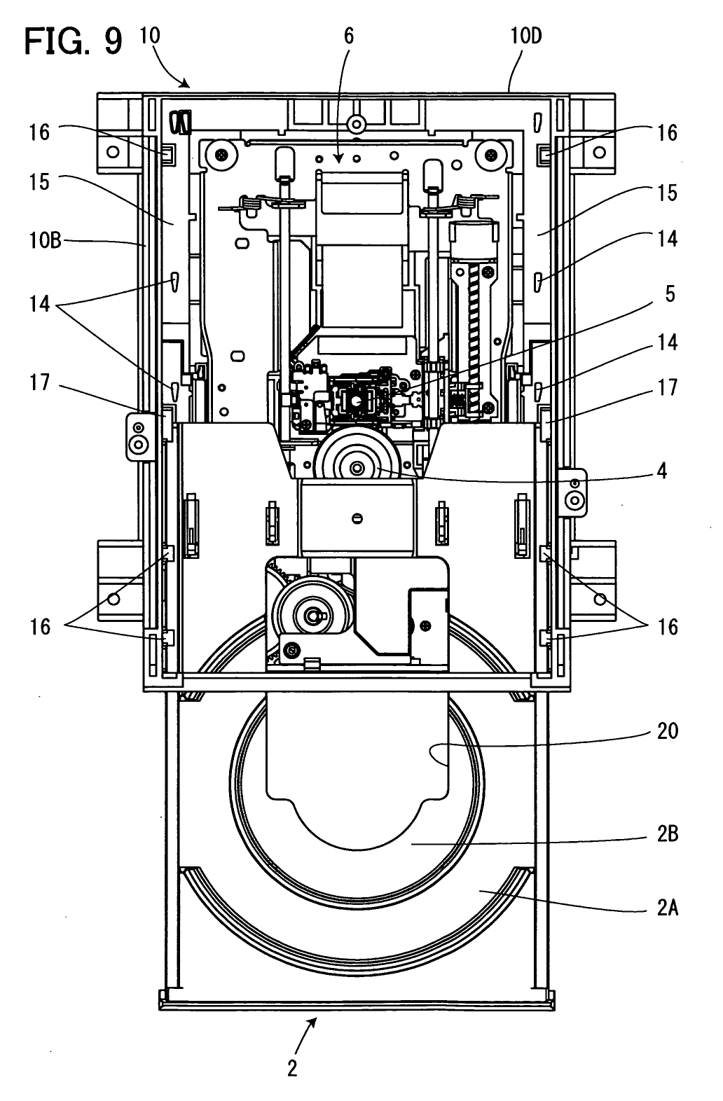

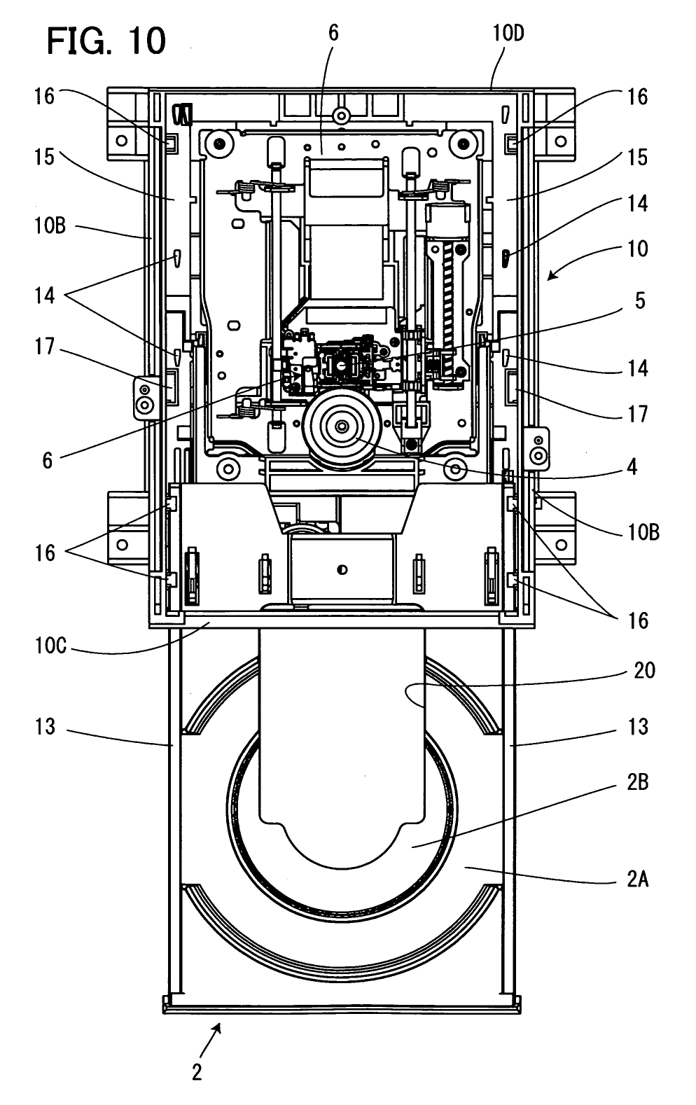

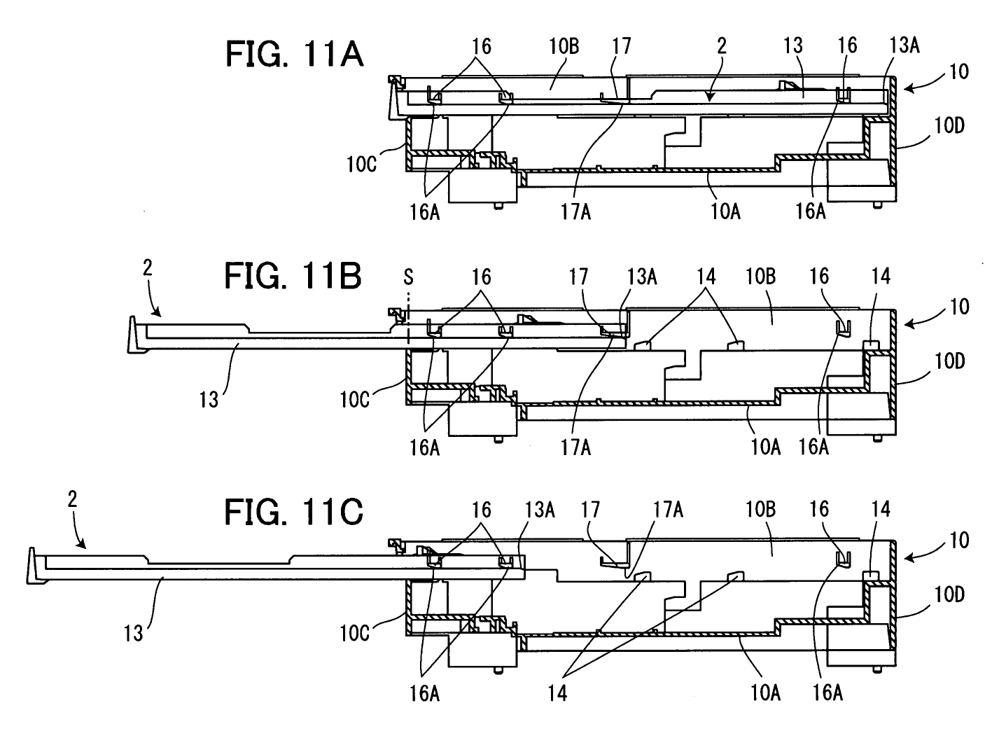

FIG. 1 to FIG. 11 show an embodiment of the present invention, FIG. 1 is a perspective view of a disk device showing an embodiment of the present invention, FIG. 2 is a perspective view showing a frame as a single unit, FIG. 3 is a plan view showing the frame as a single unit, FIG. 4 is a cross-sectional view showing the frame as a single unit, FIG. 5 is a perspective view showing a tray as a single unit, FIG. 6 shows a plan view and a back view showing the tray as a single unit, FIG. 7 is a perspective view of the disk device showing a state in which the cover has been removed, FIG. 8 is a plan view of the disk device in a state in which the cover has been removed at the disk reproducing position, FIG. 9 is a plan view of the disk device with the cover removed showing a moving condition of the tray, FIG. 10 is a plan view of the disk device with the cover removed at the disk loading/unloading position and FIG. 11 is a cross-sectional view showing the positional relationship between the tray and the frame.

As shown in the above figures, a disk device 1 of this embodiment is constructed of a tray 2 which carries in/out a disk (not shown), a turntable 4 which drives the disk to rotate and a traverse unit 6 which is made up of a pickup unit 5 which can move back and forth in the radial direction of the disk or the like as main components, and a synthetic resin frame 10 to which these main components are attached.

The frame 10 is shaped like a box with a bottom made up of a horizontal plane 10A, side walls 10B integrally formed on both left and right sides of this horizontal plane 10A, a front wall 10C and a back wall section 10D integrally formed on the front and back of the horizontal plane 10A and an opening at the top thereof is hermetically sealed with a cover 11. The traverse unit 6 is mounted substantially in the center of the horizontal plane 10A, a damper 4A is fixed to the cover 11 which covers the top surface opening of the frame 10 opposite the turntable 4 attached to the traverse unit 6 and this damper 4A and turntable 4 hold the disk to drive the disk to rotate.

The tray 2 is designed to move back and forth in the horizontal direction by being supported by the horizontal plane 10A of the frame 10, a pair of left and right guide rails 13 provided with recessed grooves 12 are formed in the undersides at both edges of the tray 2 and a plurality of engaging projections 14 which engage with the recessed grooves 12 of the guide rails 13 are formed on stepped parts 15 which are formed on both sides of the horizontal plane 10A. That is, the guide rails 13 and engaging projections 14 constitute guide means for guiding the tray 2 and the tray 2 moves back and forth along the engaging projections 14 which engage with the recessed grooves 12 of the guide rails 13 between the disk loading/unloading position and the disk reproducing position. Furthermore, a plurality of guide ribs 16 protruding sideward and contacting the top surfaces of the guide rails 13 are provided on the side walls 10B of the frame 10 so as to suppress floating of the tray 2. As for these guide ribs 16, as shown in FIG. 4, two guide ribs 16 are provided side by side on the front end side of the tray 2 and one guide rib 16 is integrally formed on the back end side of the tray 2, and further an inclination relaxation rib 17 is integrally formed as inclination relaxation means for suppressing an abrupt inclination of the tray 2 substantially in the center of the side walls 10B of the frame 10 aligned with the three guide ribs 16. These guide ribs 16 and inclination relaxation rib 17 are provided side by side spaced apart from each other in the horizontal direction so as to contact the top surfaces of the guide rails 13 when the guide rails 13 of the tray 2 move along the engaging projections 14 of the frame 10. That is, the floating of the tray 2 is suppressed by the guide ribs 16 and inclination relaxation rib 17 formed in the frame 10.

The inclination relaxation rib 17 is formed on the inner surface of the frame 10 in such a way that when the tray 2 moves, the inclination relaxation rib 17 contacts the top surface at the back end of the guide rail 13 at a position at which the center of gravity of the tray 2 is located between one part of the tray 2 which protrudes from the frame 10 and another part of the tray 2 inside the frame 10, that is, the position of the center of gravity S of the tray 2 reaches the front wall 10C of the frame 10 as shown in FIG. 11B. Furthermore, inclined planes 16A and 17A which gradually lower from the front end sides of the guide rib 16 and the inclination relaxation rib 17 which become the receiving sides of the guide rail 13 in the direction in which the tray 2 is inserted are formed on the undersides of the guide rib 16 and the inclination relaxation rib 17 which contact the guide rail 13 so as to guide the back edge of the guide rail 13 when the tray 2 moves from the disk loading/unloading position to the disk reproducing position, and a downward inclined plane 13A is also formed at the back end of the guide rail 13.

Furthermore, the tray 2 is molded through injection molding or the like and molded into a flat plate shape as a whole. Substantially circular stepped recessed parts 2A and 2B are formed in the top surface of this tray 2 as shown in FIG. 5, a disk such as a 12 cm CD can be mounted on the first recessed part 2A and a disk such as an 8 cm CD can be mounted on the second recessed part 2B. Furthermore, an opening window section 20 is formed in the tray 2 so as to prevent mechanical interfere with the turntable 4 and the pickup unit 5 when the tray 2 is housed in the frame 10.

In the disk device 1 constructed as described above, when the tray 2 is moved from the inside of the frame 10 to the outside of the frame 10 through a tray drive mechanism (not shown), driving of the tray 2 is stopped by a stopper mechanism (not shown) with the recessed parts 2A and 2B formed in the top surface of the tray 2 completely exposed to the outside of the frame 10, which makes it possible to mount a disk on the recessed part 2A or 2B or remove a disk mounted on the recessed part 2A or 2B, and this position becomes the disk loading/unloading position (see FIG. 11C). At the disk loading/unloading position, a disk is mounted on the recessed part 2A or 2B and the tray 2 together with the disk mounted is moved to the inside of the frame 10 by the tray drive mechanism and completely housed therein. In this condition, the opening which is located substantially in the center of the disk aligns with the turntable 4 and clamper 4A and the position in this condition becomes the disk reproducing position (see FIG. 11A), the traverse unit 6 ascends and the disk is held between the turntable 4 and the damper attached to the traverse unit 6, the disk is rotated in this condition by the rotation of the turntable 4 through a rotation drive force of the motor, at the same time laser light is irradiated from the pickup unit 5, the pickup unit 5 moves in the radial direction of the disk and recording or reproducing of data onto/from the disk is performed.

Furthermore, when moving from the disk loading/unloading position to the disk reproducing position or from the disk reproducing position to the disk loading/unloading position, the tray 2 moves back and forth between the disk loading/unloading position and the disk reproducing position along the engaging projections 14 which engage with the recessed groove 12 of the guide rail 13. At this time, when the tray 2 moves, since the plurality of guide ribs 16 and inclination relaxation rib 17 integrally formed in the side wall 10B of the frame 10 contact the top surface of the guide rail 13, the guide ribs 16 and inclination relaxation rib 17 suppress the floating of the tray 2, which allows the tray 2 to be guided in a stable condition.

When the tray 2 moves from the disk reproducing position to the disk loading/unloading position, the inclination relaxation rib 17 contacts the top surface at the back end of the guide rail 13 of the tray 2 at a position at which the center of gravity of the tray 2 is located between one part of the tray 2 which protrudes from the frame 10 and another part of the tray 2 inside the frame 10, that is, a position at which the position of the center of gravity S of the tray 2 reaches the front wall 10C of the frame 10 as shown in FIG. 11B. This allows the inclination relaxation rib 17 to suppress an abrupt inclination of the tray 2 which protrudes from frame 10 and the tray 2 moves in a stable condition. As shown in FIG. 11C, the tray 2 finally completes the movement toward the disk loading/unloading position, allowing the disk to be mounted on the recessed part 2A or 2B or the disk to be replaced. Furthermore, the part of the tray 2 on the back end side is supported by the two guide ribs 16 formed on the front end side of the frame 10, which can prevent the tray 2 from coming off when the user intentionally moves the tray 2 which protrudes outside in the vertical direction.

On the other hand, the inclined planes 16A and 17A which are inclined so as to guide the guide rail 13 are formed on the undersides of the guide ribs 16 and inclination relaxation rib 17 which contact the guide rail 13 and the downward inclined plane 13A is formed at the back end of the guide rail 13, and therefore when the tray 2 moves from the disk loading/unloading position to the disk reproducing position, the back edge of the guide rail 13 of the tray 2 is smoothly guided by the inclined planes 13A, 16A and 17A, reliably guided to the guide ribs 16 and inclination relaxation rib 17 and the tray 2 finally completes the movement toward the disk reproducing position at which the tray 2 is housed inside the frame 10. The tray 2 which is at the disk reproducing position is supported by the guide ribs 16 and inclination relaxation rib 17 at the front, back and middle positions. Furthermore, while the guide rail 13 of the tray 2 is in contact with the guide ribs 16 and the inclination relaxation rib 17, since the area of contact of the guide rail 13 with the guide ribs 16 and inclination relaxation rib 17 through the inclined planes 16A and 17A is also small, it is possible to reduce the possibility that abnormal sound or abrasion powder may be produced by friction at the time of contact of the guide rail 13 with the guide ribs 16 and inclination relaxation rib 17.

As described above, the disk device 1 of this embodiment is designed such that when moving the tray 2 forward or backward, the plurality of guide ribs 16 and the inclination relaxation rib 17 integrally formed on the side wall 10B of the frame 10 are made to contact the top surface of the guide rail 13 to suppress the floating of the tray 2, and when the tray 2 moves, the inclination relaxation rib 17 contacts the top surface at the back end of the guide rail 13 of the tray 2 at a position at which the center of gravity of the tray 2 is located between one part of the tray 2 which protrudes from the frame 10 and another part of the tray 2 inside the frame 10, that is, a position at which the center of gravity S of the tray 2 reaches the front wall 10C of the frame 10, and therefore it is possible to prevent the tray 2 which protrudes from the frame 10 from abruptly inclining by the own weight and realize a stable movement and operation of the tray 2 which allows improvement of quality. Furthermore, the inclined planes 16A and 17A are formed on the undersides of the guide ribs 16 and inclination relaxation rib 17 which contact the guide rail 13 respectively, and the inclined plane 13A is also formed at the back end of the guide rail 13, and it is thereby possible to smoothly guide the guide rail 13 to the guide ribs 16 and inclination relaxation rib 17 and reliably guide the guide rail 13. Furthermore, the inclined planes 16A and 17A can suppress the area of contact of the guide rail 13 with the guide ribs 16 and inclination relaxation rib 17 to a small level and reduce the possibility that abnormal sound or abrasion powder may be produced at the time of contact of the guide rail 13 with the guide ribs 16 and inclination relaxation rib 17.

Furthermore, since the disk is set on the recessed part 2A or 2B of the tray 2 or the disk is removed from the recessed part 2A or 2B at the disk loading/unloading position at which the tray 2 protrudes from frame 10 most, the possibility that the user may touch the tray 2 causing the tray 2 to incline upward or downward is highest, but by supporting the part on the back end side of the tray 2 which is at the disk loading/unloading position with the two guide ribs 16 formed on the front end side of the frame 10, it is possible to keep the tray 2 in an extremely stable condition. Furthermore, the inclination relaxation rib 17 which suppresses an abrupt inclination of the tray 2 during movement functions as a guide rib to suppress the floating of the frame 10, which also facilitates molding work on the frame 10.

One embodiment of the present invention has been explained in detail so far, but the present invention is not limited to the above described embodiment, and can be implemented modified in various ways within a range not departing from the essence of the present invention. For example, the case where the guide ribs 16 and inclination relaxation rib 17 for guiding the guide rail 13 and the flat inclined planes 13A, 16A and 17A at the back end of the guide rail 13 are formed has been explained as an example, but they may also be formed as curved planes, and the shape and the number of guide ribs 16 and inclination relaxation ribs 17 can be selected as appropriate. Furthermore, the basic structure or the like of the disk device 1 is not limited to the above described embodiment either and can be selected as appropriate.

The effects of the present invention are as follows.

The disk device provided with a tray according to the first aspect of the present invention includes a tray on which a disk-shaped storage medium is mounted, a frame which supports the tray and guiding means for guiding the tray between a disk loading/unloading position and a disk reproducing position in a manner freely movable back and forth, wherein the frame is provided with inclination relaxation means for suppressing an abrupt inclination of the tray which occurs when the tray is carried out of the frame and moved, and therefore when carrying the tray out of the disk reproducing position and moving it to the disk loading/unloading position, the inclination relaxation means prevents the tray from abruptly inclining at a position where the weight of the tray which protrudes from the frame becomes greater than the weight of the tray inside the frame and it is thereby possible to realize a stable tray carrying out operation without degrading the quality.

The disk device provided with a tray according to the second aspect of the present invention is the disk device provided with a tray according to the first aspect of the present invention, wherein the frame is provided with a horizontal plane which guides the tray and side walls integrally formed on both left and right sides of the horizontal plane, the guide means comprises guide rails formed in undersides of both edges of the tray and engaging projections which protrude from the horizontal plane and engage with recessed grooves of the guide rails, and a plurality of guide ribs are integrally formed on inner surfaces of the side walls of the frame so as to contact top surfaces of the guide rails and suppress floating of the tray, and therefore when moving the tray from the disk loading/unloading position to the disk reproducing position or from the disk reproducing position to the disk loading/unloading position, the plurality of guide ribs formed on the inner surfaces of the side walls of the frame prevent the tray from floating and it is thereby possible to move the tray in a stable condition.

The disk device provided with a tray according to the third aspect of the present invention is the disk device provided with a tray according to the first or the second aspect of the present invention, wherein the inclination relaxation means is provided so as to contact a top surface of a back part of the tray when a center of gravity of the tray is located between a part of the tray which at least protrudes from the frame and another part of the tray inside the frame, and therefore it is possible to prevent the tray from abruptly inclining when the center of gravity of the tray is located between a part of the tray which protrudes from the frame, which corresponds to a most unstable condition when the tray moves and another part of the tray inside the frame and move the tray in a stable condition.

The disk device provided with a tray according to the fourth aspect of the present invention is the disk device provided with a tray according to the third aspect of the present invention, wherein the inclination relaxation means is constructed of an inclination relaxation rib which is located between the guide ribs and integrally formed on an inner surface of the side wall, and therefore when the center of gravity of the tray is located between a part of the tray which protrudes from the frame, which corresponds to a most unstable condition when the tray moves and another part of the tray inside the frame, the top surface of the back part of the tray is made to contact the inclination relaxation ribs, thereby preventing the tray from abruptly inclining, allowing the tray to move in a stable condition and allowing the inclination relaxation ribs to also function as the guide ribs to suppress floating of the tray, which also facilitates molding work on the frame.

The disk device provided with a tray according to the fifth aspect of the present invention is the disk device provided with a tray according to the fourth aspect of the present invention, wherein inclined planes or curved planes are formed on the underside of the inclination relaxation rib which contacts the tray in such a way as to gradually lower from an end on the tray receiving side in a direction in which the tray is inserted from the disk loading/unloading position to the disk reproducing position, and therefore it is possible to reliably guide the guide rails of the tray to the inclination relaxation ribs and the area of contact the guide rails with the inclination relaxation ribs is also small, and this can thereby prevent the generation of abnormal sound and abrasion powder or the like due to friction when the guide rails contact the inclination relaxation ribs.

The disk device provided with a tray according to the sixth aspect of the present invention is the disk device provided with a tray according to the fifth aspect of the present invention, wherein downward inclined planes or curved planes are formed at back ends of the guide rails, and therefore it is possible to reliably guide the guide rails of the tray to the inclination relaxation ribs.

What is claimed is:

1. A disk device provided with a tray comprising:
a tray on which a disk-shaped storage medium is mounted;
a frame which supports the tray; and
guiding means for guiding the tray between a disk loading/unloading position and a disk reproducing position in a manner freely movable back and forth,
wherein the frame is provided with inclination relaxation means for suppressing an abrupt inclination of the tray which occurs when the tray is carried out of the frame and moved.

2. The disk device provided with a tray according to claim 1,
wherein the frame is provided with a horizontal plane which guides the tray and side walls integrally formed on both left and right sides of the horizontal plane,
the guide means comprises guide rails formed in undersides of both edges of the tray and engaging projections which protrude from the horizontal plane and engage with recessed grooves of the guide rails, and
a plurality of guide ribs are integrally formed on inner surfaces of the side walls of the frame so as to contact top surfaces of the guide rails and suppress floating of the tray.

3. The disk device provided with a tray according to claim 1, wherein the inclination relaxation means is provided so as to contact a top surface of a back part of the tray when a center of gravity of the tray is located between a part of the tray which at least protrudes from the frame and another part of the tray inside the frame.

4. The disk device provided with a tray according to claim 2, wherein the inclination relaxation means is provided so as to contact a top surface of a back part of the tray when a center of gravity of the tray is located between a part of the tray which at least protrudes from the frame and another part of the tray inside the frame.

5. The disk device provided with a tray according to claim 3, wherein the inclination relaxation means is constructed of an inclination relaxation rib which is located between the guide ribs and integrally formed on an inner surface of the side wall.

6. The disk device provided with a tray according to claim 4, wherein the inclination relaxation means is constructed of an inclination relaxation rib which is located between the guide ribs and integrally formed on an inner surface of the side wall.

7. The disk device provided with a tray according to claim 5, wherein inclined planes or curved planes are formed on the underside of the inclination relaxation rib which contacts the tray in such a way as to gradually lower from an end on the tray receiving side in a direction in which the tray is inserted from the disk loading/unloading position to the disk reproducing position.

8. The disk device provided with a tray according to claim 6, wherein inclined planes or curved planes are formed on the underside of the inclination relaxation rib which contacts the tray in such a way as to gradually lower from an end on the tray receiving side in a direction in which the tray is inserted from the disk loading/unloading position to the disk reproducing position.

9. The disk device provided with a tray according to claim 7, wherein downward inclined planes or curved planes are formed at back ends of the guide rails.

10. The disk device provided with a tray according to claim 8, wherein downward inclined planes or curved planes are formed at back ends of the guide rails.
